(19) United States
(12) Patent Application Publication
(10) Pub. No.: US 2004/0131915 A1
(43) Pub. Date: Jul. 8, 2004

(54) Solid oxide fuel cell stack

(76) Inventors: Scott Sherman, Calgary (CA); Glenn Price, Calgary (CA); Mehrzad Tabatabaian, Calgary (CA); Brett Wightman, Calgary (CA); Athal Christie, Calgary (CA); Martin Perry, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/707,229

(22) Filed: Nov. 28, 2003

Related U.S. Application Data
(60) Provisional application No. 60/319,740, filed on Nov. 28, 2002.

(51) Int. Cl. H01M 2/08; H01M 8/24

(52) U.S. Cl. 429/35; 429/38

(57) ABSTRACT

A solid oxide fuel cell stack configuration includes reactant flow fields bounded horizontally by seals and vertically by the fuel cell on one side and an interconnect on the other. The stack footprint may be rectangular with triangular reactant manifolds disposed in each corner, surrounding a central electrode area, which may be hexagonal in shape.

### CROSS REFERENCE TO RELATED APPLICATIONS

This application claims the priority benefit of U.S. Provisional Application No. 60/319,740 filed on Nov. 28, 2003 entitled “Solid Oxide Fuel Cell Stack”, the contents of which are incorporated herein by reference.

### BACKGROUND OF INVENTION

The present invention relates to solid oxide fuel cells and, more particularly, to a stack configuration of fuel cells, interconnects and seals.

A solid oxide fuel cell produces electricity by electrochemically reacting oxidant and fuel without combustion. The reactants are supplied to the cell through manifolds and flow fields that direct reactants to the appropriate sides of a solid ceramic membrane that acts as an electrolyte. The membrane is coated with electrodes on both sides and permits transfer of ions of the oxidant, but does not permit transfer of electrons. Thus the streams of reactants are kept separate, but the electrons and ions from the reactants are allowed to react. Electrons are emitted at the fuel side electrode of the solid electrolyte membrane and absorbed at the oxygen side electrode thereby generating a potential difference between the two electrodes. The solid electrolyte membrane separates the reactants; transfers the charge in the form of ions and, at the same time, prevents an electron short circuit between the two electrodes of the solid electrolyte. For this purpose, the solid electrolyte membrane has a low electronic conductivity but at the same time, a high ionic conductivity.

Fuel cell membranes are separated by interconnects, or bipolar plates, which serve to direct reactant flow to the electrodes and to collect current generated by the fuel cell. Solid oxide fuel cells typically operate at high temperatures, in the range of 600° C. to about 1000° C. This temperature range limits the selection of materials available for use in an interconnect that are able to withstand this temperature, and to simultaneously withstand an oxidizing environment on one side of the interconnect, and a partial reducing environment on the other. Most prior art interconnects have used ceramic materials and composites, however these materials demonstrate inferior electrical conductivity as compared to metals, and typically are not successful in withstanding both oxidizing and reducing environments simultaneously.

Ceramic materials also are expensive to purchase as raw materials, require moulding or other processing, and then firing or sintering. These steps are all labour intensive and require significant amounts of time to process. In addition, the fine tolerances that are required in a solid oxide fuel cell stack are difficult to maintain when a green ceramic is sintered. Furthermore, ceramic materials are brittle, and there can be significant losses during production due to handling and processing damage that occurs in the manufacture of the interconnect. Ceramic materials are also vibration and shock intolerant, which makes them unsuitable for applications such as in automobiles.

Metallic interconnects which are machined from solid metal plates are known but are also difficult to manufacture and as a result are expensive. There have been attempts to form metallic interconnects by bonding stacked metal plates together however such attempts have not been successful because of leaks forming between the metal plates and their inability to withstand the operating temperatures of solid oxide fuel cells. For example, U.S. Pat. No. 3,484,298 discloses a laminated electrode backing plate which is laminated using adhesives or other bonding agents.

In Applicant's commonly owned U.S. patent application Ser. No. 09/682,817, a three-layer metallic interconnect which comprises three die-cut or stamped layers brazed together is disclosed. Although brazing reduces the cost compared to machined interconnects, the cutting and brazing steps are still expensive and time-consuming. At the same time, consistent electrode contact is difficult to maintain.

These prior art interconnect designs deliver reactant gases through the interconnect to the electrode surface. As a result, not only are seals required around the four reactant manifolds of a fuel cell stack but also around the electrode surface area, as shown in prior art FIG. 1.

Accordingly, there is a need in the art for a fuel cell stack configuration including interconnects, fuel cells and seals which mitigates the disadvantages of the prior art.

### SUMMARY OF INVENTION

The present invention relates to a novel solid oxide fuel cell stack configuration which comprises solid, unitary interconnects and seal-defined flow fields for directing reactants to the fuel cell electrodes.

In one aspect, the invention comprises a fuel cell apparatus comprising a vertically repeating series of planar fuel cell units wherein each unit comprises:

(a)an interconnect having an anode-facing surface and a cathode-facing surface and defining a fuel intake manifold, a fuel exhaust manifold, an air intake manifold and an air exhaust manifold;

(b)a planar fuel cell having a cathode and an anode and, optionally, a fuel cell holder plate, wherein the fuel cell or fuel cell holder plate defines a fuel intake manifold, a fuel exhaust manifold, an air intake manifold and an air exhaust manifold, each of which align vertically with a corresponding manifold in the interconnect;

(c)a cathode gasket seal disposed between the fuel cell or fuel cell holder plate and the cathode-facing surface of the interconnect and defining a cathode flow field wherein the air intake manifold and the air exhaust manifold are within the cathode flow field;

(d)an anode gasket seal disposed between the fuel cell or fuel cell holder plate and the anode-facing surface of the interconnect and defining an anode flow field wherein the fuel intake manifold and fuel exhaust manifold are within the anode flow field;

(e)first and second fuel manifold seals disposed between the fuel cell holder plate and an interconnect for isolating each of the fuel intake and exhaust manifolds respectively; and

(f)first and second air manifold seals disposed between the fuel cell holder plate and an interconnect for isolating each of the air intake and exhaust manifolds respectively.

In one embodiment, the anode or cathode gasket seal, and the manifold seals are formed by a single seal element. Alternatively, the manifold seals may be separate seal elements from the anode or cathode gasket seals.

In one embodiment, a first porous contact material is disposed between the cathode and the cathode-facing surface of the interconnect, within the cathode flow field, and a second porous contact material is disposed between the anode and the anode-facing surface of the interconnect, within the anode flow field.

Preferably, the cathode-facing surface of the interconnect comprises flow directing ribs for distributing air relatively evenly along the fuel cell cathode surface. The flow directing ribs may be stamped into the interconnect. In one embodiment, both the anode-facing and cathode-facing surface comprise flow-directing ribs.

In one embodiment, the fuel cell unit has a footprint comprising a substantially quadrilateral shape and wherein each of the anode flow field and the cathode flow field are disposed diagonally across the footprint. The footprint may comprise a substantially rectangular shape. The fuel cell may be hexagonal wherein first opposing lateral sides of the fuel cell border the air intake and exhaust manifolds respectively and second opposing lateral sides border the fuel intake and exhaust manifolds. In another embodiment, the fuel cell may be quadrilateral and the anode and cathode flow fields are disposed parallel or perpendicular across the footprint.

In another aspect, the invention may comprise a fuel cell stack comprising alternating layers of interconnects, seals, fuel cells and defining a horizontal anode flow field in fluid communication with a vertical fuel intake manifold and a vertical fuel exhaust manifold, and further defining a horizontal cathode flow field in fluid communication with a vertical air intake manifold and a vertical air exhaust manifold, wherein each of the anode flow field and the cathode flow field is horizontally contained by a compressible seal. In one embodiment, the fuel cell stack has a footprint comprising a substantially rectangular shape and the anode flow field and the cathode flow field are each disposed diagonally across the stack footprint. In one embodiment, each fuel cell comprises a hexagonally shaped anode surface and a hexagonally shaped cathode surface, each exposed to the anode flow field and cathode flow field respectively.

### BRIEF DESCRIPTION OF DRAWINGS

The invention will now be described by way of an exemplary embodiment with reference to the accompanying simplified, diagrammatic, not-to-scale drawings. In the drawings:

FIG. 1 (prior art) is a schematic representation of a prior art fuel cell stack and interconnect.

FIG. 2A is a top view of one embodiment of an interconnect of the present invention, showing a seal-defined cathode flow field. FIG. 2B shows the underside of the interconnect shown in FIG. 2A, showing a seal-defined anode flow field.

FIG. 3 is an exploded perspective view of the components of a fuel cell unit.

FIG. 4A shows one embodiment of a interconnect plate.

FIG. 4B shows one embodiment of a cell holder plate matching the interconnect.

FIG. 5 is a cross-sectional view of stacked fuel cell units along line 5-5 in FIG. 3.

FIG. 6 is a detailed cross-sectional view of a fuel cell unit along 6-6 in FIG. 3.

### DETAILED DESCRIPTION

The present invention provides for a solid oxide fuel cell stack system. When describing the present invention, all terms not defined herein have their common art-recognized meanings. A fuel cell stack consists of a repeating series of fuel cells, interconnects and seals wherein the seals and interconnects define fuel and air flowfields on each side of each fuel cell, isolating each of the fuel and air delivery and exhaust systems. As used herein, “vertical” or “vertically” shall refer to a direction normal to the planar elements of the fuel cell stack. Accordingly, “horizontal” or “horizontally” shall refer to a direction parallel to the planar elements.

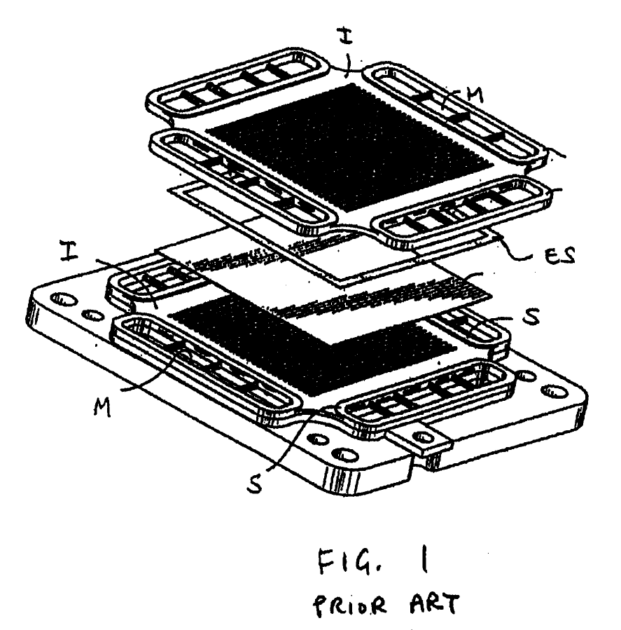

In FIG. 1, a prior art fuel cell stack is illustrated. In this system, air and fuel flows from the manifolds (M) through internal passages in the interconnect (I) separated by a central barrier plate within the interconnect. Accordingly, seals (S) are provided around each manifold opening and an electrode seal (ES) around the flow field which contacts the anode or cathode.

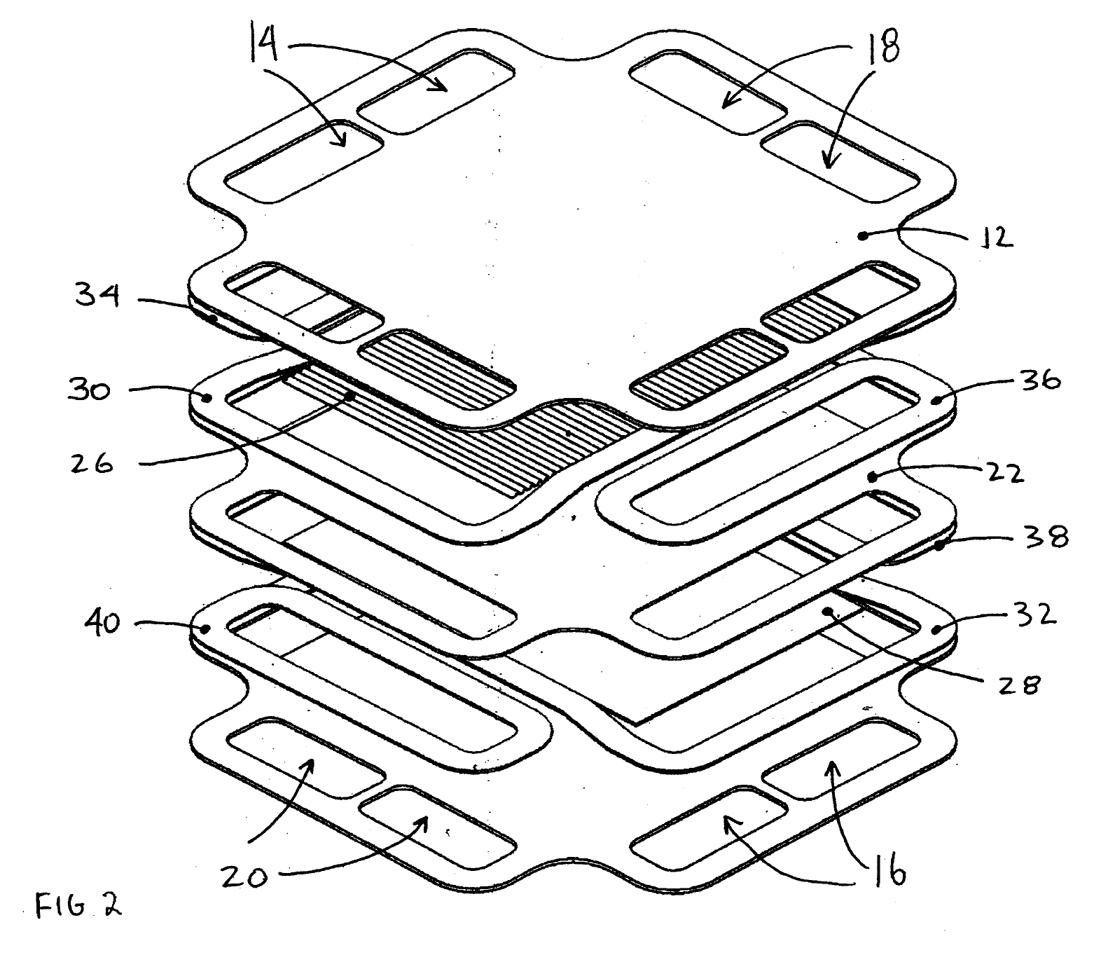

FIG. 2 illustrates a basic embodiment of a fuel cell unit (10) of the present invention. A fuel cell stack comprises a plurality of these units stacked vertically. Each unit comprises an interconnect (12) having an upper anode surface and a lower cathode surface and defining a fuel intake manifold (14), a fuel exhaust manifold (16), an air intake manifold (18) and an air exhaust manifold (20). In the embodiment shown, the anode and cathode surfaces are square areas while the manifolds are openings disposed around the central electrode area. Below the interconnect is a planar fuel cell element (22) having a cathode surface and an anode surface. In one embodiment, the fuel cell element has the same shape as the interconnect, to allow for vertical alignment, and is internally manifolded, defining a fuel intake manifold (14), a fuel exhaust manifold (16), an air intake manifold (18) and an air exhaust manifold (20). In an alternative embodiment, the fuel cell element may be framed by a fuel cell holder plate (24), in which case the fuel cell element and the holder plate fit together to form a planar element. The manifolds of the fuel cell (22) or the fuel cell holder plate (24) each align vertically with the corresponding manifold in the interconnect (12).

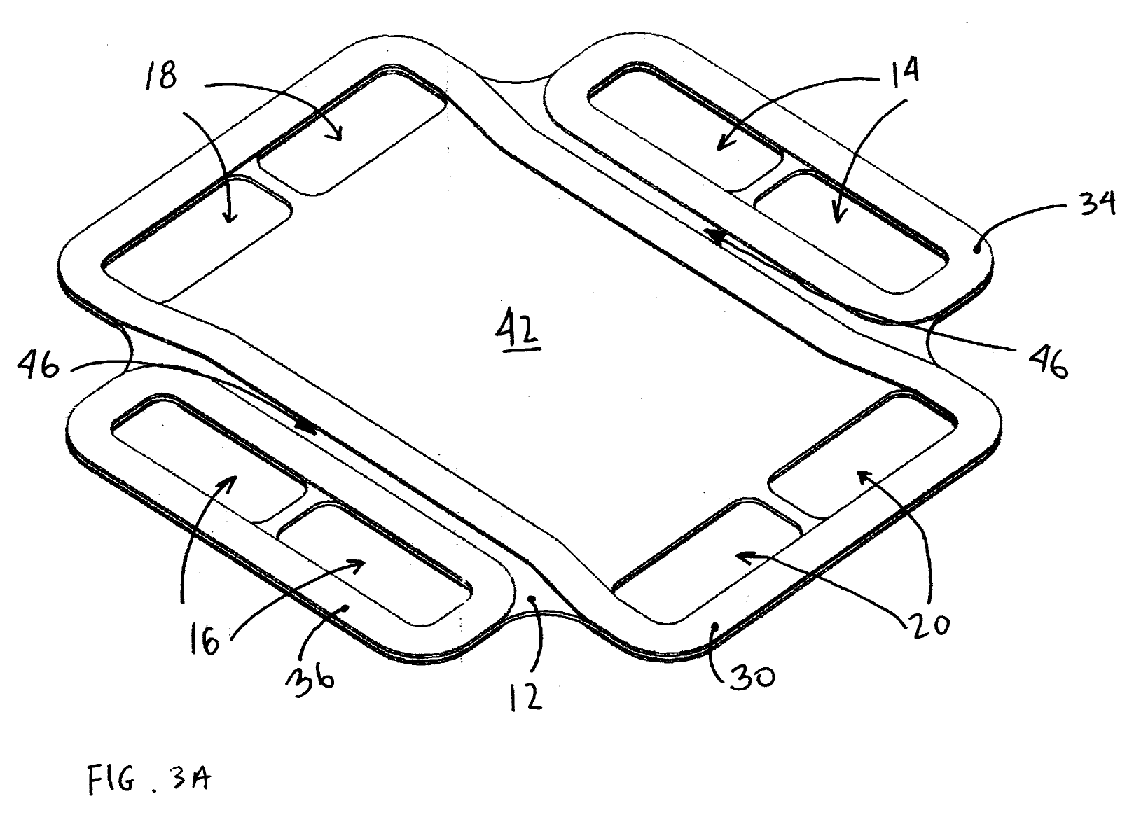

Reactant flow in the manifolds and across opposing sides of the fuel cell is directed by seals as may be seen in FIG. 2 and in FIGS. 3A and 3B . On the cathode side of the fuel cell (22), a cathode gasket seal (30) surrounds the air intake and exhaust manifolds (18, 20) and the cathode-facing surface (42) of the interconnect (12), while excluding the fuel intake and exhaust manifolds (14, 16). Each of the fuel intake and exhaust manifolds (14, 16) is surrounded by separate seals (34, 36). On the anode side of the fuel cell, an anode gasket seal (32) surrounds the fuel intake and exhaust manifolds (14, 16) and the anode surface (44) of the fuel cell, while excluding the air intake and exhaust manifolds (16, 18). Accordingly, the vertical manifolds formed in the stack by the aligned manifold openings (14, 16, 18, 20) feed reactants to the appropriate side of the fuel cell through a flow field bounded horizontally by a gasket seal (30 or 32) and vertically by the fuel cell electrode (42 or 44) and the interconnect (12).

Air or oxidant flow is depicted in FIG. 2 by arrows (A). Fuel flow is depicted in FIG. 2 by arrows (F).

We have found that a fuel cell unit having a rectangular footprint, vertical manifolds having a roughly triangular cross-sectional shape placed in each corner, and a central hexagonal electrode area is an efficient configuration. As used herein, a “footprint” shall refer to the horizontal cross-sectional shape of the stack or unit. The shape of the footprint or the flow fields is not intended to be an essential element of the invention unless specifically claimed as such.

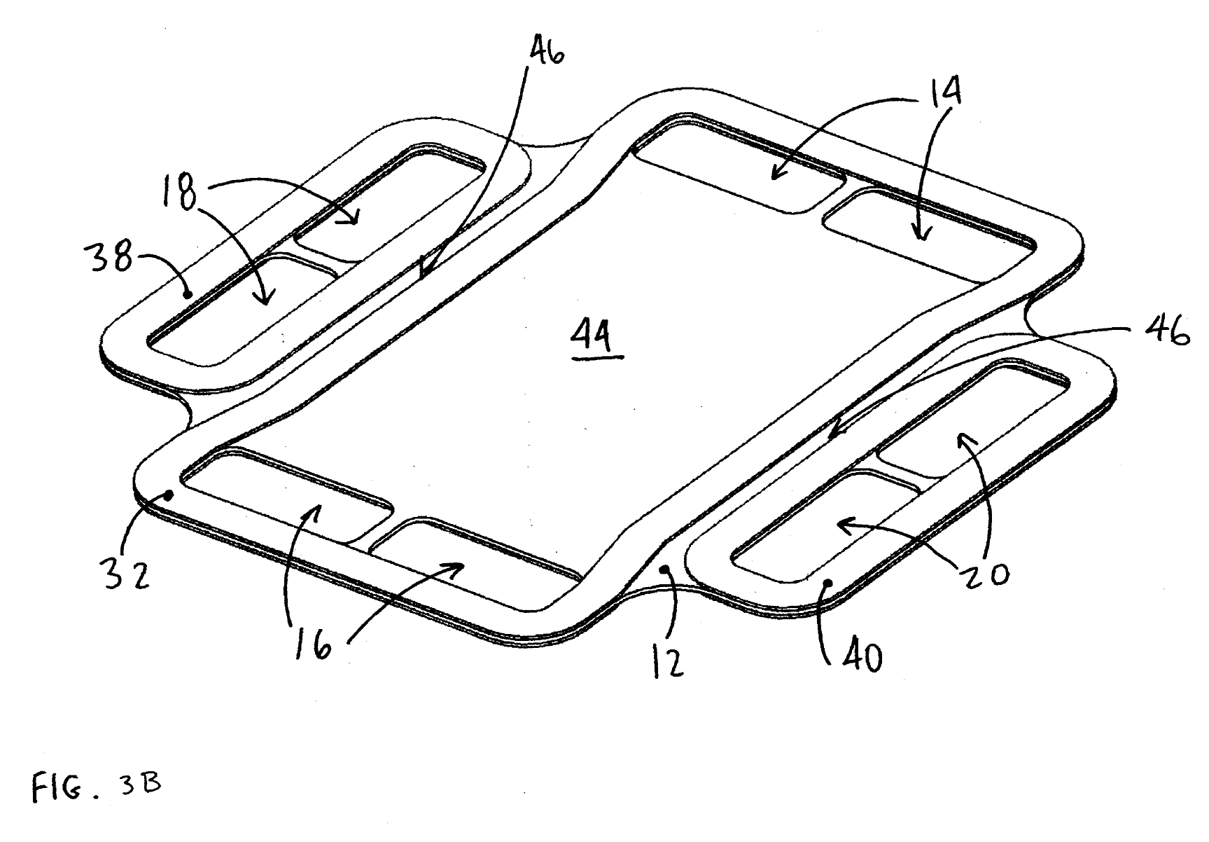

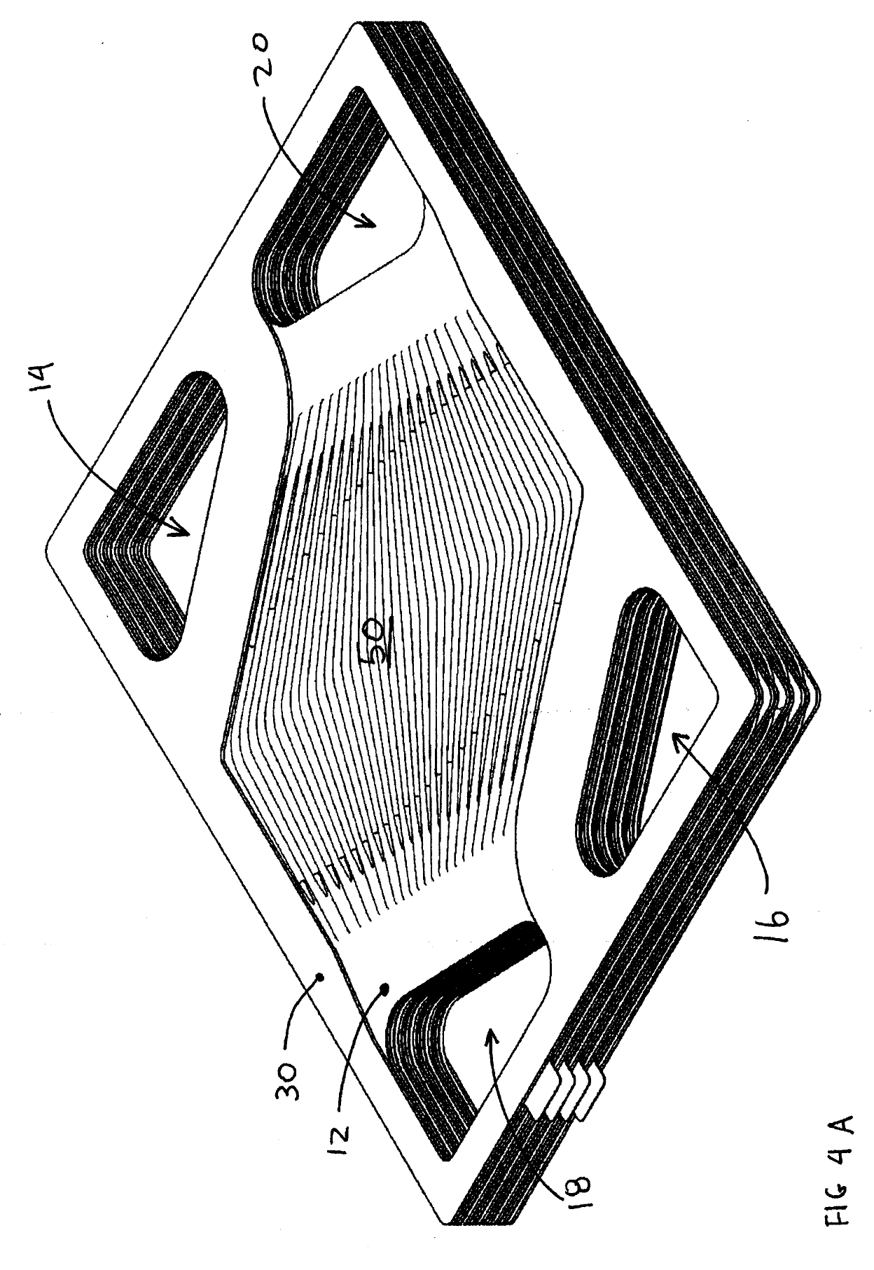

Therefore, in one embodiment, the cell (22) may be hexagonal in shape and mate with a cell holder plate (24) which defines the manifolds. The interconnect (12) may therefore be configured as shown in FIG. 4A and a cell holder plate (24) may be configured as shown in FIG. 4B. The cell (22) fits within the central opening of the cell holder plate (24) and forms a planar unit with the cell holder plate (24). Gasket seals (30, 32) between the interconnect and the cell holder plate direct gas flow diagonally from an intake manifold to an exhaust manifold. FIG. 4A shows the cathode side (50) of the interconnect (12) and therefore, the flow field created by the cathode gasket seal (30) includes the air intake manifold (18) and the air exhaust manifold (20).

On the opposite side of the cell holder plate and cell, the anode gasket seal (32) creates an anode (44) flow field including the fuel intake and exhaust manifolds (14, 16) while sealing the air intake and exhaust manifolds (18, 20).

In one embodiment, as shown in FIGS. 4A and 4B, a single seal element may be formed which combines the separate seals shown in FIG. 2. Cathode seals (30, 34, 36) may be combined into a single seal, while anode seals (32, 38, 40) may be combined into a single seal. In this case, each of the cathode and anode gasket seals (30, 32) seals the peripheral edge of the interconnect and defines three openings. A central flow field opening serves to define the reactant flow field across the fuel cell electrode, while the remaining two openings serve to define and exclude the opposing intake and exhaust manifolds.

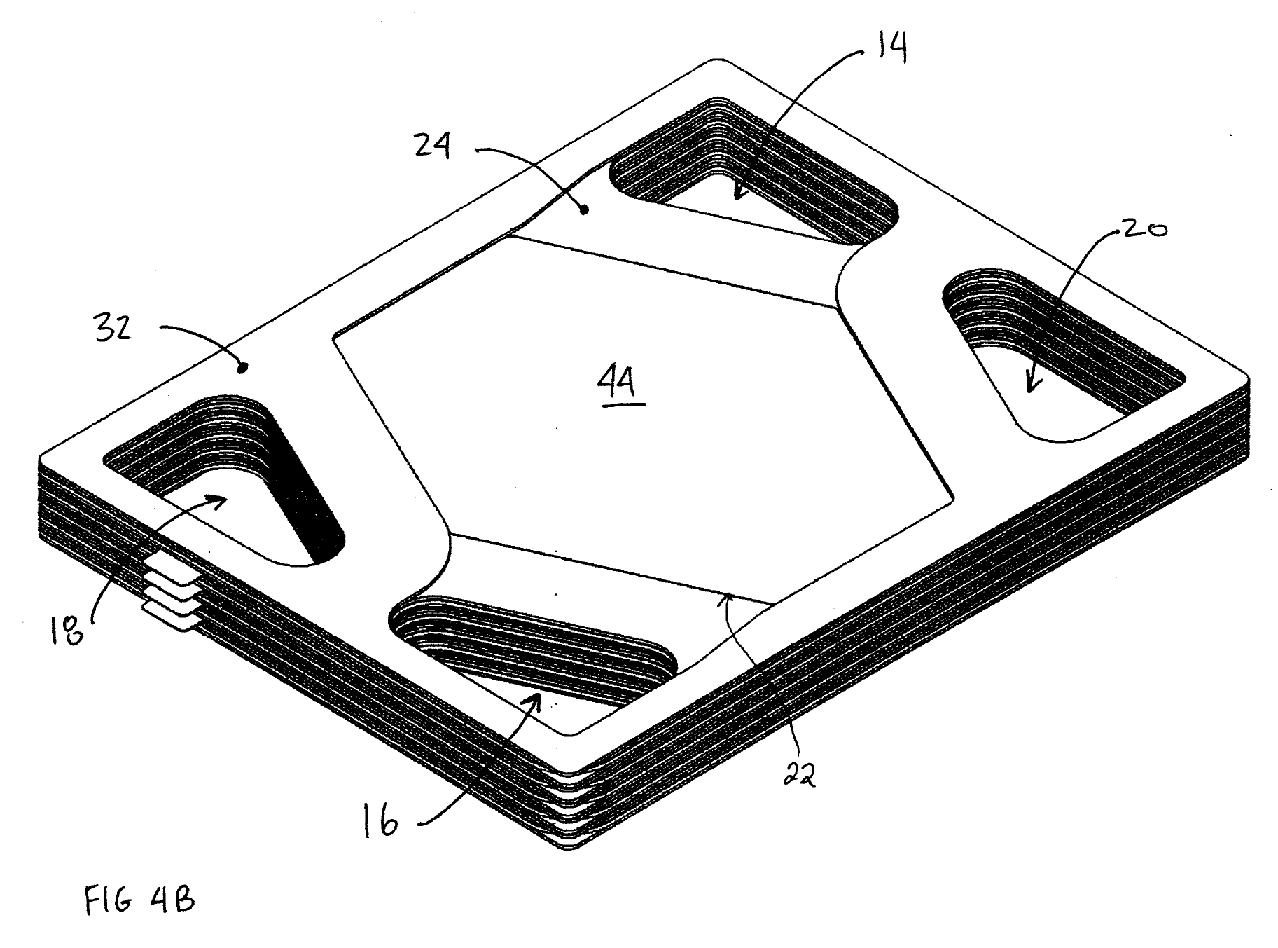

The vertical depth of the flow field is governed by the thickness of the seals which separates the interconnect (12) from the electrode. If the seals are compressible, which is preferred but not required, the compressed thickness of the seal defines the depth of the flow field in the assembled stack. In one embodiment, the seals may be comprised of a single uniform seal material. Alternatively, each seal may be a laminated seal, comprised of two compressible seals sandwiching a thin metal strip (11), as illustrated in FIG. 5. Suitable compressible seals may include mica or a partially dense ceramic material. A preferred seal material may include a ceramic felt or paper which is impregnated with small particles which may be metal, glass or ceramic. A preferred compressible seal material is described in Applicant's co-pending U.S. patent application Ser. No. 09/931,415 filed on Aug. 17, 2001, or 60/319,811 filed on Dec. 24, 2002, the contents of which are both incorporated herein by reference.

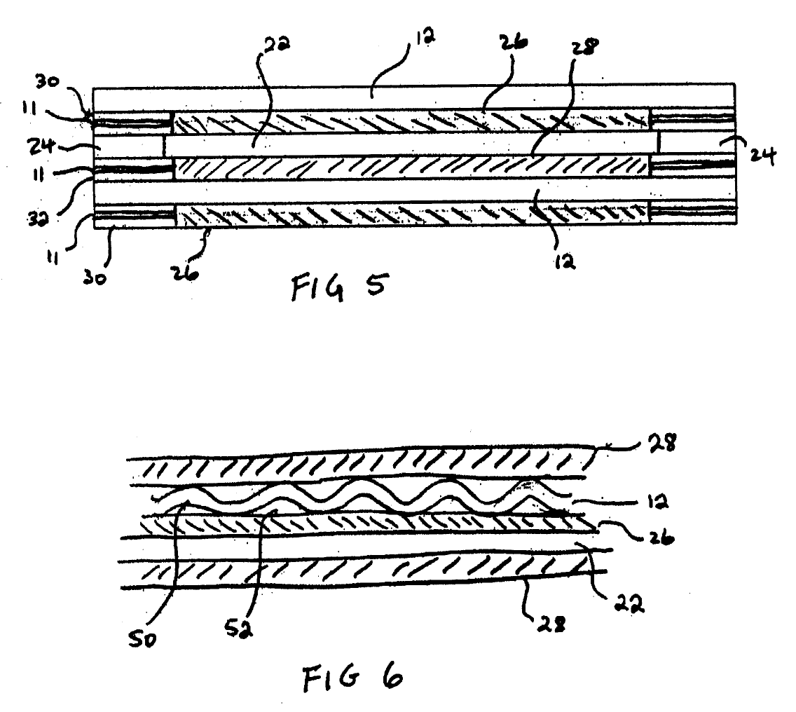

In one embodiment, the interconnects (12) serve as current collectors and therefore must be in electrical contact with the fuel cell electrodes. Therefore, a first porous electrically conducting contact material (26) is disposed between the cathode surface and the cathode surface of the interconnect as shown in FIG. 6 while a second porous contact material (28) is disposed between the anode surface and the upper surface of a lower interconnect. Obviously, the lower interconnect is the upper interconnect (12) of the fuel cell unit immediately below and adjacent to the unit described herein.

In one embodiment, both the cathode contact material (26) and the anode contact material (28) may comprise any porous, electrically conducting material which is chemically compatible with the fuel cell and oxidizing gases or reducing atmospheres. In one embodiment, the material comprises an expanded metal or nickel foam or their equivalent. A suitable expanded metal may include an expanded stainless steel. Suitable nickel foam may include nickel having between about 50 pores per inch to about 90 pores per inch. Suitable nickel foam is commercially available and may have a density between about 500 g/m² and 1500 g/m² of material ranging in thickness 1.3 to about 1.7 mm thick. The contact material may be slightly thicker than the flow field and therefore will be compressed slightly upon assembly of the fuel cell stack.

It is known that compressible seals formed of ceramic fibres and ceramic particles are not hermetic gas seals and some minor gas leakage must be anticipated. In the present invention, it is possible to provide gas leak paths (46) between the anode gasket seal (32) and the adjacent air manifold seals (38, 40) and between the cathode gasket seal (30) and the adjacent fuel manifold seals (34, 36), as is shown in FIGS. 3A and 3B. Because the fuel cell stack typically operates above the auto-ignition temperature of the fuel, the fuel which leaks from the anode gasket seal and the fuel manifold seals will ignite in the gas leak path. Provided that fuel leakage rates are not significant, this combustion within the fuel cell stack may be easily tolerated. The gas leak paths ensure that the combustion occurs away from the electrode surfaces.

In an alternative embodiment, there are no gas leak paths, and separate flow field and manifold seals are not provided. The seal may then be a single seal having three openings as shown in FIGS. 4A and 4B.

As referred to above, a porous, electrically conducting element (28) may be provided between the anode and the lower interconnect. This element may be expanded metal or nickel foam as described above. Similarly, a porous, electrically conducting element (26) may be provided in the cathode flow field. Preferably, the cathode element comprises a contact paste which hardens to form a porous ceramic material. The contact paste may be applied as a green ceramic paste to the cathode or the interconnect, or both, during assembly of the fuel cell stack. In one embodiment, the element comprises lanthanum cobalt oxide (LaCoO3) or lanthanum cobaltate (LC) which has very good electrical conductivity properties. This layer is not prefired prior to operation in the stack, since it is preferred to avoid sintering of the LC layer. Once sintered, the LC layer has a thermal expansion rate about twice that of the remaining components in the fuel cell, with the resultant sealing and bonding problems due to thermal movement. Also, LC can chemically react with YSZ forming undesirable phases at the high temperature encountered during sintering.

In a preferred embodiment, the interconnect is embossed to form ribs (50) which influence reactant flow through the flow field. As is seen in FIG. 4A, the ribs (50) diverge from the air intake manifold (18) to the widest part of the flow field and from there, converge to the air exhaust manifold (20). Therefore, the ribs (50) serve to evenly distribute air flow over the entire surface area of the cathode, in the cathode flow field. As may be seen in FIG. 6, the ribs form flow channels (52) in the cathode flow field and permit a thinner layer of contact paste (26) to be applied. Additionally, in one embodiment, the ribs may be formed in the anode side of the interconnect to influence fuel flow through the anode flow field.

The ribs (50) may be conveniently formed in the interconnect (12) by embossing or stamping the interconnect plate. Alternatively, the ribs may be glued, brazed or otherwise attached to the interconnect plate.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A fuel cell apparatus comprising a vertically repeating series of fuel cell units (10) wherein each unit comprises:
(a)an interconnect having an anode-facing surface and a cathode-facing surface and defining a fuel intake manifold, a fuel exhaust manifold, an air intake manifold and an air exhaust manifold;
(b)a planar fuel cell having a cathode and an anode and, optionally, a fuel cell holder plate, wherein the fuel cell or fuel cell holder plate defines a fuel intake manifold, a fuel exhaust manifold, an air intake manifold and an air exhaust manifold, each of which align vertically with a corresponding manifold in the interconnect;
(c)a cathode gasket seal disposed between the fuel cell or fuel cell holder plate and the cathode-facing surface of the interconnect and defining a cathode flow field wherein the air intake manifold and the air exhaust manifold are within the cathode flow field;
(d)an anode gasket seal disposed between the fuel cell or fuel cell holder plate and the anode-facing surface of the interconnect and defining an anode flow field wherein the fuel intake manifold and fuel exhaust manifold are within the anode flow field;
(e)first and second fuel manifold seals disposed between the fuel cell holder plate and an interconnect for isolating each of the fuel intake and exhaust manifolds respectively; and
(f)first and second air manifold seals disposed between the fuel cell holder plate and an interconnect for isolating each of the air intake and exhaust manifolds respectively.

2. The apparatus of claim 1 wherein the cathode gasket seal, and first and second fuel manifold seals are formed by a single seal element.

3. The apparatus of claim 1 wherein the anode gasket seal, and first and second air manifold seals are formed by a single seal element.

4. The apparatus of claim 1 further comprising a first porous contact material disposed between the cathode and the cathode-facing surface of the interconnect, within the cathode flow field, and a second porous contact material disposed between the anode and the anode-facing surface of the interconnect, within the anode flow field.

5. The apparatus of claim 1 wherein the cathode surface of the upper interconnect comprises flow directing ribs for distributing air relatively evenly along the fuel cell cathode surface.

6. The apparatus of claim 5 wherein the flow directing ribs are stamped into the interconnect.

7. The apparatus of claim 1 wherein the fuel cell unit has a footprint comprising a substantially quadrilateral shape and wherein each of the anode gas chamber and the cathode gas chamber are disposed diagonally across the footprint.

8. The apparatus of claim 7 wherein the footprint comprises a substantially rectangular shape.

9. The apparatus of claim 8 wherein the fuel cell is hexagonal wherein first opposing lateral sides of the fuel cell borders first and second lateral edges of the fuel cell holder plate, second opposing lateral sides of the fuel cell border the air intake and exhaust manifolds respectively and third opposing lateral sides border the fuel intake and exhaust manifolds.

10. The apparatus of claim 1 wherein a leak path gap is provided between the cathode gasket seal and the first and second fuel manifold seals.

11. The apparatus of claim 1 wherein a leak path gap is provided between the anode gasket seal and the first and second air manifold seals.

12. A fuel cell stack comprising alternating layers of interconnects, seals, fuel cells and defining a horizontal anode flow field in fluid communication with a vertical fuel intake manifold and a vertical fuel exhaust manifold, and further defining a horizontal cathode flow field in fluid communication with a vertical air intake manifold and a vertical air exhaust manifold, wherein each of the anode flow field and the cathode flow field is horizontally contained by a compressible seal.

13. The fuel cell stack of claim 12 wherein the fuel cell stack has a footprint comprising a substantially rectangular shape.

14. The fuel cell stack of claim 13 wherein the anode flow field and the cathode flow field are each disposed diagonally across the stack footprint.

15. The fuel cell stack of claim 14 wherein each fuel cell comprises a hexagonally shaped anode surface and a hexagonally shaped cathode surface, each exposed to the anode flow field and cathode flow field respectively.
